(19) United States
(12) Patent Application Publication
(10) Pub. No.: US 2026/0036923 A1
(43) Pub. Date: Feb. 5, 2026

(54) MAGNETIC CARRIER, AND TWO-COMPONENT DEVELOPER CONTAINING MAGNETIC CARRIER

(71) Applicant: KYOCERA Document Solutions Inc., Osaka (JP)

(72) Inventor: Yusuke KURANO, Osaka (JP)

(73) Assignee: KYOCERA Document Solutions Inc., Osaka (JP)

(21) Appl. No.: 19/273,452

(22) Filed: Jul. 18, 2025

(30) Foreign Application Priority Data
Aug. 5, 2024 (JP) 2024-129168

(51) Int. Cl. G03G 9/113; G03G 9/107

(52) U.S. Cl. CPC G03G 9/1136; G03G 9/1085

(57) ABSTRACT

Magnetic carrier includes a carrier core and a resin coat layer. The magnetic carrier electrostatically charges toner positively by friction. The resin coat layer coats the surface of the carrier core. The resin coat layer contains polyimide silicone resin and fluorine-containing resin.

### INCORPORATION BY REFERENCE

This application is based on and claims the benefit of priority from Japanese Patent Application No. 2024-129168 filed on Aug. 5, 2024, the contents of which are hereby incorporated by reference.

### BACKGROUND

The present disclosure relates to magnetic carrier that electrostatically charges toner by friction and also relates to two-component developer containing magnetic carrier.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image. Known methods for developing an electrostatic latent image include two-component development, which uses as developer, two-component developer containing toner and magnetic carrier, and one-component development, which uses one-component developer containing no magnetic carrier. For higher image quality and faster printing, two-component developer is suitably used.

Two-component developer used in two-component development contains magnetic carrier and toner, of which only the toner is consumed in development and the carrier is repeatedly used while being stirred in a developing device. To cope with increasingly high durability desired nowadays, as carrier particles, use is made of resin-coated magnetic particles in which the surface of the magnetic particle is coated with resin.

### SUMMARY

According to one aspect of the present disclosure, magnetic carrier includes a carrier core and a resin coat layer. The magnetic carrier electrostatically charges toner positively by friction. The resin coat layer coats the surface of the carrier core. The resin coat layer contains polyimide silicone resin and fluorine-containing resin.

### DETAILED DESCRIPTION

An embodiment of the present disclosure will be described in detail below. Unless otherwise defined, a result of evaluation (i.e., a value related to a shape, property, or the like) with respect to a powdery substance (specifically, toner core particle, toner base particle, external additive, toner, and the like) is given as a number average of values obtained by measuring respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750” produced by HORIBA, Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂=CH—CO—) and “methacryloyl” (CH₂=C(CH₃)—CO—) collectively.

The magnetic carrier according to the present disclosure is a powdery substance composed of a plurality of carrier particles (each a particle configured as described later). Moreover, the carrier particle according to the present disclosure has a carrier core and a resin layer coating the carrier core. To produce a carrier particle, the carrier core can be formed of a magnetic material (e.g., ferrite), or the carrier core can be formed of resin having magnetic particles dispersed in it. Or, magnetic particles can be dispersed in the resin layer that coats the carrier core.

The magnetic carrier according to the present disclosure electrostatically charges positively chargeable toner positively by friction. It along with the positively chargeable toner constitutes two-component developer, which can be used suitably for the development of an electrostatic latent image. To form a high-quality image, the amount of toner in two-component developer is preferably 5 parts by mass or more but 15 parts by mass or less for 100 parts by mass of carrier. Note that positively chargeable toner is electrostatically charged positively by friction with carrier.

The magnetic carrier according to the embodiment can be used to form an image, for example, on an electrophotographic apparatus (image forming apparatus). One example of an image forming method on an electrophotographic apparatus will be described below.

First, based on image data, an electrostatic latent image is formed on a photosensitive member (e.g., a superficial part of a photosensitive drum). Next, the formed electrostatic latent image is developed with two-component developer containing toner and carrier. In the development process, toner (e.g., toner electrostatically charged positively by friction with the carrier) on a development sleeve (e.g., a superficial part of a development roller in the developing device) disposed near the photosensitive member is attached to the electrostatic latent image to form a toner image on the photosensitive member. In the subsequent transfer process, the toner image on the photosensitive member is directly transferred to a recording medium (e.g., sheet); or it is primarily transferred to an intermediate transfer member (e.g., a transfer belt) and then the toner image on the intermediate transfer member is secondarily transferred to the recording medium. Then, the toner is heated to fix the toner to the recording medium. As a result, an image is formed on the recording medium. By superposing on each other toner images of four colors, for example, black, yellow, magenta, and cyan, it is possible to form a full-color image.

### [1. Basic Configuration of Magnetic Carrier]

The magnetic carrier according to the embodiment has a basic configuration as described below. The magnetic carrier includes a plurality of carrier particles having a magnetic carrier core and a resin layer. The resin layer coats the surface of the magnetic carrier core. The resin layer can coat the entire surface of the magnetic carrier core or can partly coat the surface of the magnetic carrier core. The resin layer contains polyimide silicone resin and fluorine resin. The fluorine resin is fluorine element-containing-resin that contains a fluorine atom in its chemical structure.

Polyimide silicone resin excels in toner filming properties and durability and has low water vapor permeability. Fluorine resin excels in the ability to give electrostatic chargeability to the positively chargeable toner. Thus, by forming an image using the magnetic carrier having the basic configuration described above, it is possible to provide carrier that excels in the ability to give electrostatic chargeability and in the ability to retain electric charge even in a high-temperature high-humidity environment and to form a high-quality image for a long period.

### [2. Basic Configuration of Toner]

The magnetic carrier according to the embodiment can be blended with toner for use as two-component developer. As toner used with the magnetic carrier, any known positively chargeable toner for two-component developer can be used.

Toner includes a plurality of toner particles each having a toner core particle. The toner core particle at least contains a binder resin, a release agent, and a colorant. The toner core particle can have its surface coated with a shell layer. The shell layer preferably coats 50% or more but 99% or less of the area of a surface region of the toner core particle. The toner core particle can have its entire surface coated with the shell layer. If the toner core particle is coated with a shell layer, the particle composed of the toner core particle and the shell layer is referred to as a toner base particle. If the toner core particle is coated with no shell layer, the toner core particle alone is referred to as a toner base particle.

The thickness of the shell layer can be measured by observing a section of the toner using a transmission electron microscope (TEM) and analyzing the TEM image using a commercially available image analysis software. Usable as commercially available image analysis software are “WinROOF” (developed by MITANI CORPORATION) and the like. How the shell layer coats the surface of the toner can be checked using a scanning electron microscope (SEM). How the shell layer is formed or the inside of the shell layer can be checked by observing a section of the toner using a transmission electron microscope (TEM).

The toner base particle can have an external additive attached to its surface. As the external additive, inorganic fine particles or resin fine particles can be used. Attaching resin fine particles as the external additive to the toner base particle tends to improve the cleaning properties (e.g., adhesion resistance against the photosensitive drum) of the toner as well as its development properties (e.g., transferring efficiency). This is considered to be because, with the resin fine particles functioning as a spacer, the toner less tends to attach to the photosensitive drum, an intermediate transfer belt, or the like.

### [3. Material and Production Method of Magnetic Carrier]

Next, components that are essential or optional for the magnetic carrier according to the present disclosure will be described. The magnetic carrier according to the present disclosure at least includes a carrier core and a resin layer. The magnetic carrier can also include a conductive agent in the resin layer. Now, a description will be given one by one of the carrier core that forms the magnetic carrier particle, the resin material that forms the resin layer, the conductive agent, and a method of producing the magnetic carrier according to the present disclosure.

### (Carrier Core)

The carrier core is not particularly limited and any known carrier for electrophotography employing a two-component system can be used. Examples include: ferrite or magnetite; metal such as iron, nickel, and cobalt; an alloy or a mixture of any of the metals and the like just mentioned with a metal such as copper, zinc, antimony, aluminum, lead, tin, bismuth, beryllium, manganese, magnesium, selenium, tungsten, zirconium, vanadium; a mixture of any of ferrite and the like just mentioned with a metal oxide such as iron oxide, titanium oxide, and magnesium oxide, a nitride such as chrome nitride and vanadium nitride, or a carbide such as silicon carbide and tungsten carbide; and ferromagnetic ferrite. Particularly preferred are ferrite and magnetite.

The volume average particle size of the carrier core is preferably 20 to 70 μm. This helps obtain satisfactory development properties. The volume average particle size can be measured using a laser diffraction/scattering particle size distribution analyzer. Usable as a laser diffraction/scattering particle size distribution analyzer is, for example, LA-700 (manufactured by HORIBA, Ltd.).

### (Resin Material)

As the resin constituting the resin coat layer, a mixture of polyimide silicone resin, which excels in toner filming and durability and which has low water vapor permeability, with fluorine-containing resin, which excels in toner filming and the ability to give electrostatic chargeability to the positively chargeable toner. Preferred as the fluorine-containing resin is one or more resins selected from the group consisting of polyvinyl fluoride, polyvinylidene fluoride, tetrafluoroethylene-hexafluoropropylene copolymer (FEP), polytrifluoroethylene (more specifically, polychlorotrifluoroethylene and the like), polyhexafluoropropylene, tetrafluoroethylene-perfluoroalkyl vinyl ether copolymer (PFA), and polytetrafluoroethylene (PTFE). Particularly preferred are FEP, PFA, and PTFE.

Polyimide silicone resin is a copolymer having a polyimide structure and a polysiloxane structure (e.g., alkyl polysiloxane structure). Examples of polyimide silicone resin include “KJR-651,” “KJR-655,” “KJR-657,” and “KJR-663” (all manufactured by Shin-Etsu Chemical Co., Ltd.). Polyimide silicone resin can be a resin obtained by setting a thermoset polyimide silicone resin.

The mixing ratio of polyimide silicone resin to fluorine resin is preferably 1:9 to 9:1 by mass, and more preferably 2:8 to 8:2.

### (Conductive Agent)

Preferably the resin coat layer additionally contains a conductive agent. The resin coat layer additionally containing a conductive agent allows adjustment of the electric resistance of the carrier particle and its ability to give electrostatic chargeability to the toner.

Examples of the conductive agent include carbon black (specifically, conductive carbon black), metal oxide particles (e.g., titanium oxide particles and tin oxide particles), and organic conductive agent. As the conductive agent, carbon black or titanium oxide particles is preferred.

If the resin coat layer contains carbon black, the amount of carbon black contained is preferably, for 100 parts by mass of the coating resin, 1.0 parts by mass or more but 10.0 parts by mass or less, and more preferably 2.0 parts by mass or more but 6.0 parts by mass or less.

### (Additives)

The resin coat layer can contain as an additive at least one of a charge control agent, an adhesion improving agent, and a cross-linking agent. As the additive, a silane coupling agent (or a component derived from a silane coupling agent) is preferred and an aminosilane coupling agent (or a component derived from an aminosilane coupling agent) is more preferred. An aminosilane coupling agent (or a component derived from an aminosilane coupling agent) has functions as a charge control agent, an adhesion improving agent, and a cross-linking agent.

If the resin coat layer contains an additive, the amount of additive contained is preferably, for 100 parts by mass of the coating resin, 4.0 parts by mass or more but 20.0 parts by mass or less, and more preferably 8.0 parts by mass or more but 15.0 parts by mass or less.

### (Production Method for Magnetic Carrier)

One example of a production method for the carrier according to the present disclosure will be described. The production method for the carrier includes an application step where a resin coat layer forming solution is applied to carrier cores and a heating step where the carrier cores after the application step are heated. The resin coat layer forming solution contains polyimide silicone resin, fluorine-containing resin, a solvent, and other components (e.g., a conductive agent and an additive) that are added as needed. Polyimide silicone resin can be thermosetting polyimide silicone resin.

Examples of the solvent for the resin coat layer forming solution include lactam compounds (e.g., 2-pyrrolidone and N-methyl-2-pyrrolidone), ketone compounds (e.g., methyl ethyl ketone and methyl isobutyl ketone), cyclic ether compounds (e.g., tetrahydrofuran and tetrahydropyran), alcohol compounds (e.g., normal butanol and isobutanol), ester solvents (e.g., ethyl acetate and isobutyl acetate), and aromatic hydrocarbon compounds (e.g., toluene and xylene). Preferred as the solvent for the resin coat layer forming solution is N-methyl-2-pyrrolidone.

The solid content concentration of the resin coat layer forming solution is preferably 3 mass % or more but 20 mass % or less.

### (Application Step)

Examples of methods of applying the resin coat layer forming solution to the carrier core include immersing the carrier core in the resin coat layer forming solution and spraying the carrier core in a fluidized bed with the resin coat layer forming solution. In the method where the carrier core is immersed in the resin coat layer forming solution, to elevated parts of the surface of the carrier core, a small amount of resin coat layer forming solution is applied and to depressed parts of the surface of the carrier core, a large amount of resin coat layer forming solution is applied; thus the resin coat layer forming solution tends to be applied in uneven amounts. In contrast, in the method where the resin coat layer forming solution is sprayed to the carrier core in the fluidized bed, the resin coat layer forming solution tends to be applied evenly to both the elevated and depressed parts of the surface of the carrier core. Thus, preferred as the method of applying the resin coat layer forming solution to the carrier core is spraying the resin coat layer forming solution to the carrier core in the fluidized bed.

### (Heating Step)

In the step, the carrier core after the application step is heated to remove the solvent contained in the resin coat layer forming solution. If the resin coat layer forming solution contains unset polyimide silicone resin, the unset polyimide silicone resin is set by the heat. As a result, a resin coat layer is formed from the resin coat layer forming solution. The heating can be performed under the conditions of, for example, a heating temperature of 200° C. or more but 300° C. or less and a heating time of 30 minutes or more but 90 minutes or less.

### [4. Material and Production Method of Toner]

Next, components that are essential or optional for the toner to be mixed with the magnetic carrier according to the present disclosure will be described. The toner core particle at least includes, in the binder resin, a release agent, and a colorant. The toner core particle can also include a charge control agent, a magnetic powder, and the like as needed. The toner according to the present disclosure can have, if desired, its surface treated with an external additive.

A description will be given below, one by one, of the binder resin, the release agent, the charge control agent, the colorant, and the magnetic powder that form the toner core particle, a shell material for cases where the shell layer is formed, the external additive, and a method of producing the toner according to the present disclosure.

### (Binder Resin)

In the toner according to the present disclosure, the toner core particle contains a binder resin. The binder resin that can be contained in the toner core particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties on sheets, a polyester resin is preferred. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acids halide, acids anhydride, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner core particle and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly has a cross-linked structure helps improve the heat-resistant preservation properties and durability of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tends to be poor. If the glass transition point is too low, the heat-resistant preservation properties of the toner tends to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter, DSC-6200 manufactured by Seiko Instruments Inc., as a measuring instrument. 10 mg of a measurement sample is put in an aluminum pan while an empty aluminum pan is used as a reference. From the endothermic curve of the binder resin plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Colorant)

The toner core particle contains a colorant. As the colorant that can be contained in the toner core particle, any known pigment or dye that suits the color of the toner can be used. Specific examples of colorants that can be suitably added to the toner include: black pigments such as carbon black, acetylene black, lamp black, aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, permanent Red 4R, lithol red, pyrazolone red, Watchung red calcium salt, lake red D, brilliant carmine 6B, cosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these colorants can be used in combination for the purpose of adjusting the toner to the desired hue and the like.

The amount of colorant used is not particularly limited within the scope consistent with the object of the present disclosure. Specifically, the amount of colorant used is, relative to the total mass of the toner core particle, preferably 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Release Agent)

For the purpose of improving its fixing properties and offset resistance, the toner core particle can contain a release agent. The type of release agent that can be contained in the toner core particle is not particularly limited within the scope consistent with the object of the present disclosure. As the release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding these release agents to the toner core particle helps more efficiently suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by the DSC measurement falls within the range of 100° C. or more but 120° C. or less. Examples of such types of Fischer-Tropsch wax include the following products available from Sasol Ltd.: Sasol Wax Cl (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner core particle, preferably 1 mass % or more but 10 mass % or less. Using too small an amount of release agent can result in less-than-expected suppression of offsetting or image smearing in image formation; using too large an amount of release agent can result in fusing-together of toner and hence poor heat-resistant preservation properties of toner.

### (Charge Control Agent)

The toner core particle can contain a charge control agent for the purposes of improving the charge level of the toner and the charge response properties as the index of whether it can be charged to a predetermined charge level in a short time, and thereby obtaining toner with excellent durability and stability. Since the magnetic carrier according to the present disclosure is used in development with the toner positively charged, a positively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. More specific examples include: styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is, relative to the total mass of the toner core particle, preferably 0.1 mass % or more but 10 mass % or less. Using too small an amount of charge control agent makes it difficult to stably charge the toner with a predetermined polarity. This can lead to a lower-than-expected value in the image density of the formed image and make it difficult to maintain satisfactory image density for a long period. Also, the charge control agent is then difficult to disperse evenly, and this tends to cause fogging in the formed image and contamination of a latent image carrying member with toner components. Using too large an amount of charge control agent can lead to poorer resistance to environment and this tends to cause image faults in the formed image due to insufficient charging under high temperature and high humidity, contamination of a latent image carrying member with toner components, and the like.

### (Shell Material)

If the shell layer is formed on the surface of the toner core particle, the shell layer is formed of, for example, a vinyl-based resin. As the vinyl-based resin used to form the shell layer, a resin containing a charge control resin is used. With the shell layer formed of a resin containing a charge control resin, when images are formed for a long period in various environments such as a high-temperature high-humidity environment and a low-temperature low-humidity environment, it is possible to charge the toner with the desired charge amount and to form images with the desired density.

Preferably, the vinyl-based resin is a styrene-acrylic acid-based resin containing a styrene-based monomer and one or more types of acrylic acid-based monomers. The styrene-acrylic acid-based resin has strong hydrophobicity and tends to be easy to charge positively. It is considered that, forming the shell layer of styrene-acrylic acid-based resin gives it a higher affinity for the resin fine particles formed of silicone modified acrylic resin that are attached as an external additive to the toner base particle, suppressing the coming-off of the resin fine particles from the shell layer.

The amount of vinyl-based resin used is not particularly limited within the scope consistent with the object of the present disclosure. Typically, the amount of vinyl-based resin used is preferably, for 100 parts by mass of the toner core particle, I part by mass or more but 20 parts by mass or less, and more preferably 3 parts by mass or more but 15 parts by mass or less. Using too small an amount of vinyl-based resin may result in the shell layer failing to coat the entire surface of the toner core particle. If the shell layer fails to coat the entire surface of the toner core particle, the toner tends to agglomerate during storage at high temperature, leading to poor heat-resistant preservation properties. On the other hand, using too large an amount of vinyl-based resin tends to increase the thickness of the shell layer. This makes it difficult to produce toner that excels in fixing properties.

The mass average molecular weight (Mw) of the vinyl-based resin used to form the shell layer is not particularly limited within the scope consistent with the object of the present disclosure. Typically, the mass average molecular weight is preferably 20,000 or more but 1,500,000 or less, and more preferably 200,000 or more but 400,000 or less. The mass average molecular weight (Mw) of the vinyl-based resin can be measured by gel permeation chromatography according to any known method.

A method of polymerizing the monomer (monomeric substance) described above is not particularly limited within the scope consistent with the object of the present disclosure, and thus any of methods such as solution polymerization, bulk polymerization, emulsion polymerization, and suspension polymerization can be selected.

In a case where, as in emulsion polymerization or suspension polymerization, a monomer having an unsaturated bond is addition-polymerized using an aqueous solvent, a surfactant can be used. The surfactant is not particularly limited within the scope consistent with the object of the present disclosure and can be appropriately selected from the group consisting of anionic surfactants, cationic surfactants, and nonionic surfactants. Examples of anionic surfactants include sulfate ester salt-based surfactants, sulfonate salt-based surfactants, phosphate ester salt-based surfactants, and soap. Examples of cationic surfactants include amine salt-based surfactants and quaternary ammonium salt-based surfactants. Examples of nonionic surfactants include polyethylene glycol-based surfactants, alkylphenol-ethylene oxide adduct-based surfactants, and polyhydric alcohol-based surfactants that are a derivative of a polyhydric alcohol such as glycerin, sorbitol, or sorbitan. Among these surfactants, at least one of an anionic surfactant and a nonionic surfactant is preferably used. Of these surfactants, one type can be used singly or two or more can be used in combination.

### (External Additive)

In the toner, the toner base particle can have, as desired, its surface treated with an external additive. The type of external additive is not particularly limited within the scope consistent with the object of the present disclosure and thus can be selected appropriately from external additives known to be used in toner. Specific examples of suitable external additives include inorganic fine particles of silica or a metal oxide such as alumina, titanium oxide, magnesium oxide, zinc oxide, strontium titanate, or barium titanate, or resin fine particles of acrylic resin, silicone modified acrylic resin, or the like. Two or more of these external additives can be used in combination.

The particle size of the external additive is not particularly limited within the scope consistent with the object of the present disclosure. Typically, it is preferably 0.01 μm or more but 1.0 μm or less.

The amount of external additive used is not particularly limited within the scope consistent with the object of the present disclosure. Typically, it is preferably, for the total mass of the toner base particle produced with the shell layer formed on the surface of the toner core particle, 0.1 mass % or more but 10 mass % or less, and more preferably 0.2 mass % or more but 5 mass % or less. Using too small an amount of external additive tends to degrade the hydrophobicity of the toner. This makes the toner susceptible to water molecules in the air in a high-temperature high-humidity environment and tends to cause problems such as a drop in the image density of the formed image resulting from an extreme drop in the charge amount of toner as well as a drop in the flowability of the toner. On the other hand, using too large an amount of external additive may result in a drop in the image density due to the excessive charging of the toner.

Next, a production method for the toner will be described. The production method for the toner is not particularly limited so long as it can form the toner core particle and the shell layer with predetermined structures. As necessary, using as the toner base particle the toner core particle coated with the shell layer, external addition treatment can be applied to the surface of the toner base particle to attach the external additive to it. As a suitable production method for the toner described above for development of electrostatic latent images, a method for producing the toner core particle, a method for forming the shell layer, and a method for external addition treatment will be described one by one below.

### (Method for Producing Toner Core Particle)

The method for producing the toner core particle is not particularly limited so long as it can satisfactorily disperse any optional components such as a colorant, a release agent, a charge control agent, and a magnetic powder in the binder resin. In one specific example of a suitable method for producing the toner core particle, the binder resin and any components such as a colorant, a release agent, a charge control agent, and a magnetic powder are mixed using a mixer or the like; then the binder resin and the components blended in the binder resin are melted and kneaded using a kneader such as a uniaxial or biaxial extruder; and the cooled kneaded product is pulverized and classified. The average particle size of the toner core particle is not particularly limited within the scope consistent with the object of the present disclosure; in general, it is preferably 5 μm or more but 10 μm or less.

### (Method for Forming the Shell Layer)

To form the shell layer, fine particles of vinyl-based resin is attached to the surface of the toner core particle to coat it.

The method will be described more specifically. First, in a mixing apparatus, hydrochloric acid is added to ion-exchange water to prepare an aqueous solvent with weak acidity (e.g., with a pH value selected from the range of three or more but five or less). Subsequently, to the aqueous solvent with the so adjusted pH value, a dispersion liquid (suspension) of fine particles of the vinyl-based resin as a shell material and the toner core particle are added.

Subsequently, while the mixture liquid containing the shell material and the toner core particle mentioned above is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, the mixture liquid is, while being stirred, held at the predetermined holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

As described above, attaching fine particles of vinyl-based resin, which is hydrophobic, to the surface of the toner core particle in the mixture liquid and heating the mixture liquid permits the fine particles of vinyl-based resin to melt and form a film. Instead, the fine particles of vinyl-based resin can be heated in a drying step or subjected to physical impact in an external addition step, to promote their film formation.

After the shell layer is formed as described above, the dispersion liquid of toner base particles is neutralized using, for example, sodium hydroxide. Subsequently, the dispersion liquid of toner base particles is cooled to, for example, normal temperature (about 25° C.). Then, the dispersion liquid of toner base particles is filtered using, for example, a Buchner funnel. This separates the toner base particles from the liquid (solid-liquid separation) and yields toner base particles in the form of a wet cake. Next, the obtained toner base particles in the form of a wet cake are washed. The washed toner base particles are then dried. After that, as necessary, using a mixer (e.g., an FM mixer manufactured by NIPPON COKE & ENGINEERING CO., LTD.), the toner base particles and the external additive can be mixed to attach the external additive to the surface of the toner base particles. If a spray drier is used in the drying step, spraying the dispersion liquid of the external additive (e.g., silica particles) to the toner base particles makes it possible to carry out the drying step and the external addition step at the same time. In this way, toner including a large number of toner particles is produced.

The steps involved and their order in the method for producing toner described above can be freely changed depending on the desired configuration or properties of the toner. After the external addition step, the toner can be sieved. Any unnecessary step can be omitted. For example, if a commercially available product can be used as it is as a material, using the commercially available product helps eliminate a step of preparing that material. Likewise, if a reaction to form the shell layer satisfactorily proceeds without the adjustment of the pH value of the mixture liquid, a pH adjusting step can be omitted. If no external additive is attached to the surface of the toner base particle (an external addition step is omitted), the toner base particle corresponds to the toner particle. To produce toner efficiently, it is preferable to form a large number of toner particles at the same time. The toner particles produced at the same time are considered to share substantially the same configuration.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that the particles of the external additive do not sink in the toner base particle.

The toner according to the present disclosure described above excels in fixing properties and heat-resistant preservation properties. In cases where images are formed for a long period in various environments including a high-temperature high-humidity environment and low-temperature low-humidity environment, the toner can be electrostatically charged to a desired charge amount. Thus, the images can be formed with the desired density. Accordingly, the toner according to the present disclosure for development of the electrostatic latent images can be suitably used in a variety of image forming apparatuses. Now, the effects of the present disclosure will be described more specifically by way of examples. The present disclosure is not limited in any way by those examples.

### EXAMPLES

### Production Example 1

### (Production of Toner Core Particle)

As the binder resin, for 100 mass parts of polyester resin (XPE258, manufactured by Mitsui Chemicals, Inc.), 5 mass parts of polypropylene wax (660P, manufactured by SANYO CHEMICAL INDUSTRIAL CO. LTD.), 5 mass parts of carbon black (REGAL330R, manufactured by Cabot Corporation.), and 1 mass part of charge control agent (BONTRON P-51, manufactured by ORIENT CHEMICAL INDUSTRIES CO., LTD.) were weighed. All these were mixed using a Henschel mixer (FM-10B, manufactured by NIPPON COKE & ENGINEERING CO., LTD.), and then the mixture was melted and kneaded using a biaxial extruder. The obtained kneaded product was cooled, and was then pulverized and classified to obtain toner core particles with a volume average particle size of 7 μm. The volume average particle size was measured using a Coulter Counter Multisizer 3 (manufactured by Beckman Coulter, Inc.).

### Production Example 2

### (Production of Toner)

To the toner core particles obtained in production example 1, relative to their total mass, 1.0 mass % of titanium oxide (EC-100, manufactured by Titan Kogyo, Ltd.) and 0.7 mass % of hydrophobic silica (RA-200H, manufactured by NIPPON AEROSIL CO., LTD.) treated with aminosilane, were added. The mixture was then mixed for five minutes at a rotation rate of 3500 rpm using a Henschel mixer (FM-10B, manufactured by NIPPON COKE & ENGINEERING CO., LTD.) to obtain toner for development of electrostatic latent images.

### Production Example 3

(Production of Magnetic Carrier) 40 mass parts of manganese oxide (MnO), 9 mass parts of magnesium oxide (MgO), 50 mass parts of iron (III) oxide (Fe₂O₃), and 1 mass part of strontium oxide (SrO) were blended together and pulverized for two hours using a ball mill. The product was then baked for five hours at 1000° C. to obtain manganese-based ferrite particles. The obtained magnetic particles had a particle size of 40 μm and a saturation magnetization of 65 Am²/kg (under application of 3000×10^{3/4}π·A/m). Polyimide silicone resin (KJR-651, manufactured by Shin-Etsu Chemical Co., Ltd.) and tetrafluoroethylene-hexafluoropropylene copolymer (FEP) resin fine particles were dispersed at a mass ratio of 5:5 in N-methyl-2-pyrrolidone to obtain coating resin. 100 mass parts of the magnetic particles (carrier core) were spray-coated with 3 mass parts of the coating resin using a fluidized bed-coating machine. The product was then subjected to heat treatment in the fluidized bed for an hour at 230° C. to set the resin to obtain carrier of Practical Example 1 of the present disclosure.

Carrier of Practical Example 2 was obtained in a manner similar to Practical Example 1 except that polyimide silicone resin (KJR-651, manufactured by Shin-Etsu Chemical Co., Ltd.) and tetrafluoroethylene-hexafluoropropylene copolymer (FEP) resin fine particles were dispersed at a mass ratio of 2:8 in N-methyl-2-pyrrolidone to obtain coating resin.

Carrier of Practical Example 3 was obtained in a manner similar to Practical Example 1 except that polyimide silicone resin (KJR-651, manufactured by Shin-Etsu Chemical Co., Ltd.) and tetrafluoroethylene-hexafluoropropylene copolymer (FEP) resin fine particles were dispersed at a mass ratio of 8:2 in N-methyl-2-pyrrolidone to obtain coating resin.

Carrier of Practical Example 4 was obtained in a manner similar to Practical Example 1 except that, to 100 mass parts of the coating resin, 4 mass parts of carbon black (#3230B, manufactured by Mitsubishi Chemical Corporation) were added and 100 mass parts of the magnetic particles (carrier core) were spray-coated with 4 mass parts of the coating resin using a fluidized bed-coating machine.

Carrier of Practical Example 5 was obtained in a manner similar to Practical Example 1 except that, to 100 mass parts of the coating resin, 6 mass parts of titanium oxide (EC-100, manufactured by Titan Kogyo, Ltd.) were added and 100 mass parts of the magnetic particles (carrier core) were sprayed-coated with 1 mass part of the coating resin using a fluidized bed-coating machine.

Carrier of Practical Example 6 was obtained in a manner similar to Practical Example 1 except that, to 100 mass parts of the coating resin obtained by dispersing, in N-methyl-2-pyrrolidone, polyimide silicone resin (KJR-651, manufactured by Shin-Etsu Chemical Co., Ltd.) and tetrafluoroethylene-perfluoroalkylvinylether copolymer (PFA) resin fine particles at a mass ratio of 5:5, 4 mass parts of carbon black (#3230B, manufactured by Mitsubishi Chemical Corporation) were added and 100 mass parts of the magnetic carrier (carrier core) were spray-coated with 3 mass parts of the coating resin using a fluidized bed-coating machine.

Carrier of Practical Example 7 was obtained in a manner similar to Practical Example 1 except that, to 100 mass parts of the coating resin obtained by dispersing, in N-methyl-2-pyrrolidone, polyimide silicone resin (KJR-651, manufactured by Shin-Etsu Chemical Co., Ltd.) and polytetrafluoroethylene (PTFE) resin fine particles at a mass ratio of 5:5, 4 mass parts of carbon black (#3230B, manufactured by Mitsubishi Chemical Corporation) were added and 100 mass parts of the magnetic carrier (carrier core) were spray-coated with 3 mass parts of the coating resin using a fluidized bed-coating machine.

Carrier of Comparative Example 1 was obtained in a manner similar to Practical Example 1 except that polyimide resin and tetrafluoroethylene-hexafluoropropylene copolymer (FEP) resin fine particles were dispersed at a mass ratio of 5:5 in N-methyl-2-pyrrolidone to obtain coating resin.

Carrier of Comparative Example 2 was obtained in a manner similar to Practical Example 1 except that polyimide resin and tetrafluoroethylene-hexafluoropropylene copolymer (FEP) resin fine particles were dispersed at a mass ratio of 2:8 in N-methyl-2-pyrrolidone to obtain coating resin.

Carrier of Comparative Example 3 was obtained in a manner similar to Practical Example 1 except that polyimide resin and tetrafluoroethylene-hexafluoropropylene copolymer (FEP) resin fine particles were dispersed at a mass ratio of 8:2 in N-methyl-2-pyrrolidone to obtain coating resin.

Carrier of Comparative Example 4 was obtained in a manner similar to Comparative Example 1 except that, to 100 mass parts of the coating resin, 4 mass parts of carbon black (#3230B, manufactured by Mitsubishi Chemical Corporation) were added.

Carrier of Comparative Example 5 was obtained in a manner similar to Practical Example 1 except that silicone resin (SR2400, manufactured by Toray Dow Corning Corp.) was used as coating resin.

Carrier of Comparative Example 6 was obtained in a manner similar to Comparative Example 5 except that, to 100 mass parts of the coating resin, 4 mass parts of carbon black (#3230B, manufactured by Mitsubishi Chemical Corporation) were added.

Table 1 shows the resin coat layer, the ratio of resin fine particle, the coating amount, and the conductive agent of the magnetic carriers of Practical Examples 1 to 7 and Comparative Examples 1 to 6 obtained in production example 3.

TABLE 1

| | Resin Coat | Resin Fine | Coating | Conductive |
|---|---|---|---|---|
| Carrier | Layer | Particle Ratio | Amount | Agent |
| Practical Example 1 | polyimide silicone:FEP | 5:5 | 3 mass parts | |
| Practical Example 2 | polyimide silicone:FEP | 2:8 | 3 mass parts | |
| Practical Example 3 | polyimide silicone:FEP | 8:2 | 3 mass parts | |
| Practical Example 4 | polyimide silicone:FEP | 5:5 | 4 mass parts | carbon black |
| Practical Example 5 | polyimide silicone:FEP | 5:5 | 1 mass part | titanium oxide |
| Practical Example 6 | polyimide silicone:PFA | 5:5 | 3 mass parts | carbon black |
| Practical Example 7 | polyimide silicone:PTFE | 5:5 | 3 mass parts | carbon black |
| Comparative Example 1 | polyimide:FEP | 5:5 | 3 mass parts | |
| Comparative Example 2 | polyimide:FEP | 2:8 | 3 mass parts | |
| Comparative Example 3 | polyimide:FEP | 8:2 | 3 mass parts | |
| Comparative Example 4 | polyimide:FEP | 5:5 | 3 mass parts | carbon black |
| Comparative Example 5 | silicone | 10 | 3 mass parts | |
| Comparative Example 6 | silicone | 10 | 3 mass parts | carbon black |

### Production Example 4

### (Production of Two-Component Developer)

The toner obtained in production example 2 and each of the carriers of Practical Examples 1 to 7 and Comparative Examples 1 to 6 obtained in production example 3 were blended so that the product had a toner concentration of 8 mass % (i.e., the added amount of toner was 8 mass parts for 100 mass parts, that is the total amount, of toner and carrier) and the product was stirred and mixed for 30 minutes using a rocking mixer to obtain two-component developer.

### [Evaluation of Image Density and Image Fogging of Two-Component Developer]

Each of the two-component developers respectively containing the carriers of Practical Examples 1 to 7 and Comparative Examples 1 to 6 was loaded in a developing device in an evaluation machine (TASKalfa 500ci, manufactured by KYOCERA Document Solutions Inc.). In a normal-temperature normal-humidity environment (temperature: 23° C., humidity: 50%), continuous printing was performed on 5000 sheets at a coverage rate of 2% and on 5000 sheets at a coverage rate of 20%. Then the evaluation machine was left to stand still in a high-temperature high-humidity environment (32.5° C., humidity: 80%) for 48 hours. After that, in a normal-temperature normal-humidity environment (temperature: 23° C., humidity: 50%), continuous printing was performed on 100,000 sheets at a coverage rate of 5%.

### (Image Density)

The solid image density (ID) of the print results was measured using a Macbeth reflection density sensor (RD914, manufactured by GretagMacbeth Ltd.) at the following times: at the start of printing, after printing 5000 sheets at a coverage rate of 2%, after printing 5000 sheets at a coverage rate of 20%, after leaving the evaluation machine to stand still in a high-temperature high-humidity environment for 48 hours, and after printing 100,000 sheets at a coverage rate of 5%. The evaluation criteria for image density were as follows:
VERY GOOD: ID≥1.3 (very high image density, very good print result)
GOOD: 1.0≤ID<1.3 (high image density, good print result)
POOR: ID<1.0 (very low image density, poor image quality)

### (Image Fogging)

The fogging density (FD) in the blank part of the images of the print results was measured using a reflection density sensor (R710, manufactured by IHARA Corporation) at the following times: at the start of printing, after printing 5000 sheets at a coverage rate of 2%, after printing 5000 sheets at a coverage rate of 20%, after leaving the evaluation machine to stand still in a high-temperature high-humidity environment for 48 hours, and after printing 100,000 sheets at a coverage rate of 5%. The fogging density (FD) was calculated according to formula (1) below:

$$F D = ( reflection density in blank part of printing sheet ) - ( reflection density on an unprinted sheet )$$

The evaluation criteria for image fogging were as follows:
VERY GOOD: FD≤0.005 (particularly low FD, very good print result)
GOOD: 0.005<FD≤0.010 (low FD, good print result)
POOR: FD>0.010 (very high FD, poor image quality)

Table 2 shows the results of evaluation of image density and image fogging with each of the two-component developers respectively containing the carriers of Practical Examples 1 to 7 and Comparative Examples 1 to 6.

TABLE 2

| | Normal-Temperature | | | | | |
|---|---|---|---|---|---|---|
| | Normal-Humidity Environment | | | | | |
| | | | After Printing | | After Printing | |
| | Initial Stage | | on 5k sheets at 2% | | on 5k sheets at 20% | |
| | Image Density | Fogging | Image Density | Fogging | Image Density | Fogging |
| Practical Example 1 | VERY GOOD | VERY GOOD | GOOD | VERY GOOD | GOOD | GOOD |
| Practical Example 2 | VERY GOOD | VERY GOOD | GOOD | VERY GOOD | GOOD | GOOD |
| Practical Example 3 | VERY GOOD | VERY GOOD | GOOD | VERY GOOD | GOOD | GOOD |
| Practical Example 4 | VERY GOOD | VERY GOOD | VERY GOOD | VERY GOOD | VERY GOOD | GOOD |
| Practical Example 5 | VERY GOOD | VERY GOOD | VERY GOOD | VERY GOOD | VERY GOOD | GOOD |
| Practical Example 6 | VERY GOOD | VERY GOOD | VERY GOOD | VERY GOOD | VERY GOOD | GOOD |
| Practical Example 7 | VERY GOOD | VERY GOOD | GOOD | VERY GOOD | GOOD | GOOD |
| Comparative Example 1 | VERY GOOD | VERY GOOD | GOOD | VERY GOOD | GOOD | GOOD |
| Comparative Example 2 | VERY GOOD | VERY GOOD | GOOD | VERY GOOD | GOOD | GOOD |
| Comparative Example 3 | VERY GOOD | VERY GOOD | GOOD | VERY GOOD | GOOD | GOOD |
| Comparative Example 4 | VERY GOOD | VERY GOOD | VERY GOOD | VERY GOOD | VERY GOOD | GOOD |
| Comparative Example 5 | VERY GOOD | VERY GOOD | GOOD | VERY GOOD | GOOD | GOOD |
| Comparative Example 6 | VERY GOOD | VERY GOOD | VERY GOOD | VERY GOOD | VERY GOOD | GOOD |

| | | | Normal-Temperature | |
|---|---|---|---|---|
| | High-Temperature | | Normal-Humidity Environment | |
| | High-Humidity Environment | | After Printing on 100k | |
| | After Standing Still for 48 h | | sheets at 5% | |
| | Image Density | Fogging | Image Density | Fogging |
| Practical Example 1 | VERY GOOD | VERY GOOD | VERY GOOD | GOOD |
| Practical Example 2 | VERY GOOD | VERY GOOD | VERY GOOD | GOOD |
| Practical Example 3 | VERY GOOD | VERY GOOD | VERY GOOD | GOOD |
| Practical Example 4 | VERY GOOD | GOOD | VERY GOOD | GOOD |
| Practical Example 5 | VERY GOOD | GOOD | GOOD | GOOD |
| Practical Example 6 | VERY GOOD | GOOD | VERY GOOD | GOOD |
| Practical Example 7 | VERY GOOD | GOOD | VERY GOOD | GOOD |
| Comparative Example 1 | GOOD | POOR | GOOD | GOOD |
| Comparative Example 2 | GOOD | POOR | GOOD | GOOD |
| Comparative Example 3 | GOOD | POOR | GOOD | GOOD |
| Comparative Example 4 | GOOD | POOR | GOOD | GOOD |
| Comparative Example 5 | GOOD | POOR | VERY GOOD | GOOD |
| Comparative Example 6 | GOOD | POOR | VERY GOOD | GOOD |

Table 2 clearly shows the following: the carriers of Practical Examples 1 to 7, which used polyimide silicone resin and one of FEP, PFA, and PTFE to coat the carrier core, were very good or good in both image density and image fogging after durability printing in a normal-temperature normal-humidity environment and after standing-still in a high-temperature high-humidity environment for 48 hours.

In particular, Practical Examples 4 to 6, which used polyimide silicone resin and one of FEP and PFA to coat the carrier core with a conductive agent added to the resin coat layer, were very good in image density after printing in a normal-temperature normal-humidity environment at a printing rate of 2% and 20%. On the other hand, Practical Examples 1 to 3 with no conductive agent added to the resin coat layer were very good in image fogging after standing-still in a high-temperature high-humidity environment for 48 hours.

In contrast, the carriers of Comparative Examples 1 to 4, which used polyimide resin and FEP to coat the carrier core, and the carriers of Comparative Examples 5 and 6, which used silicone resin to coat the carrier core, were poor in image fogging after standing-still in a high-temperature high-humidity environment for 48 hours.

The results above show that using magnetic carrier that has a carrier core of which the surface is coated with polyimide silicone resin and fluorine-containing resin yields two-component developer that is good in image density at the start of printing, after durability printing, and in a high-temperature high-humidity environment and that helps suppress image fogging.

The present disclosure finds application in magnetic carrier that electrostatically charges toner by friction. Based on the present disclosure, it is possible to provide magnetic carrier for use in electrophotography and two-component developer that excels in the ability to give electrostatic chargeability and in the ability to retain electric charge even in a high-temperature high-humidity environment and that permits development with high durability and high-image quality.

What is claimed is:

1. Magnetic carrier that electrostatically charges toner positively by friction, the magnetic carrier comprising:
a carrier core; and
a resin coat layer that coats a surface of the carrier core,
wherein
the resin coat layer contains polyimide silicone resin and fluorine-containing resin.

2. The magnetic carrier according to claim 1, wherein
the resin coat layer contains a conductive agent.

3. The magnetic carrier according to claim 2, wherein
the conductive agent is carbon black or titanium oxide.

4. The magnetic carrier according to claim 1, wherein
the resin coat layer has a mixing ratio of the polyimide silicone resin to the fluorine-containing resin of 2:8 to 8:2.

5. Two-component developer comprising;
the magnetic carrier according to claim 1; and
toner electrostatically charged positively by friction with the magnetic carrier.
